(19) United States
(12) Patent Application Publication
(10) Pub. No.: US 2017/0174285 A1
(43) Pub. Date: Jun. 22, 2017

(54) GRAVITY SENSOR CONTROL SYSTEM OF ELECTRIC SCOOTER

(71) Applicant: ZHEJIANG EASY VEHICLE CO., LTD, Zhejiang (CN)

(72) Inventor: Sam YU, Zhejiang (CN)

(21) Appl. No.: 15/389,155

(22) Filed: Dec. 22, 2016

(30) Foreign Application Priority Data
Dec. 22, 2015 (CN) 201510976693.2

(51) Int. Cl. B62K 11/00; B60L 15/20

(52) U.S. Cl. CPC B62K 11/007; B60L 15/2036; B62K 2202/00; B60Y 2400/30; B60Y 2300/18; B62K 2207/00; B60L 2240/421; B60L 2240/32

(57) ABSTRACT

The present invention relates to a gravity sensor control system for an electric scooter, including a controller, and a gravity sensor, a drive motor and a decelerating device connected to the controller respectively, wherein the drive motor and the decelerating device are connected to wheels respectively; the gravity sensor is arranged underneath a footrest of the electric scooter and used for detecting the gravity supported by the footrest; and the controller gets a gravity center change of a human body based on a gravity variation value, namely increment value, detected by the gravity sensor, and controls wheel speeds and/or directions through the drive motor and the decelerating device based on the gravity center change. The gravity sensor control system of the present invention is more humanized, and capable of getting an intention of a driver to accelerate, decelerate or turn based on a slight change of a gravity center of a human body, with many manipulating devices omitted, thus achieving simpler and more convenient manipulation, and improved safety performance.

### CROSS-REFERENCE TO RELATED APPLICATIONS

Under 35 U.S.C. §119(b), this application claims priority to Chinese Patent Application No. 201510976693.2 filed Dec. 22, 2015, the contents of which are hereby incorporated herein by reference in their entirety.

### TECHNICAL FIELD

The present invention relates to the field of electric scooters, and in particular relates to a gravity sensor control system of an electric scooter.

### BACKGROUND

With the surge of energy prices and prominent damage of greenhouse gas to the environment, and along with increasingly serious traffic jams, one tends to choose public transport, and at the same time, with the development of various means of transport, traditional ways of commuting are changed unknowingly.

Electric scooters at present, especially those for adults, are very advantageous in ultra-short-distance travels. An electric scooter is ridden in a standing position, and is small, light and suitable for passing through a narrow space. It has a weight much lighter than an ordinary electric vehicle, and can be carried relatively easily. It can even be stored in a trunk of a private car. For example, after one goes out and arrives at a destination, he can take it out for use when the transport device is needed, or he can use it as means of transport for a short distance from home to a bus station and for interchange in a public transport system. The existing electric scooters are complicated in structure, high in cost and cumbersome to operate, and needs further improvement and upgrade, and their batteries are unreasonable in mounting position and structure, and inconvenient to change.

### SUMMARY

### (I) Technical Problems to be Solved

A technical problem to be solved by the present invention is to solve the problem that the existing electric scooter manipulation system is complicated and not humanized in manipulation.

### (II) Technical Solution

To solve the above technical problem, the present invention provides a gravity sensor control system for an electric scooter, including a controller, and a gravity sensor, a drive motor and a decelerating device connected to the controller respectively, wherein the drive motor and the decelerating device are connected to wheels respectively; the gravity sensor is arranged underneath a footrest of the electric scooter and used for detecting the gravity supported by the footrest; and the controller gets a gravity center change of a human body based on a gravity variation value, namely, increment value, detected by the gravity sensor, and controls wheel speeds and/or directions through the drive motor and the decelerating device based on the gravity center change.

Further, when a gravity center of the human body shifts forward, the controller drives the electric scooter to move forward or accelerate through the drive motor; when the gravity of the human body shifts backward, the controller controls the electric scooter to decelerate, stop or move backward through the drive motor and the decelerating device; when the gravity of the human body shifts to the right, the controller controls a right wheel of the electric scooter to rotate more slowly or stop and a left wheel to maintain a speed through the drive motor or the decelerating device such that the electric scooter turns right; and when the gravity of the human body shifts to the left, the controller controls the left wheel of the electric scooter to rotate more slowly or stop and the right wheel to maintain a speed through the drive motor or the decelerating device such that the electric scooter turns left.

Further, the scooter is backed in such a manner that the gravity center of the human body shifts backward, and after the controller controls the electric scooter to decelerate and stop through the drive motor and the decelerating device, the gravity center of the human body continues shifting backward, and when a set backing value is reached, the controller controls the scooter to move backward through the drive motor.

Further, the controller includes a memory module for recording and storing a gravity on the gravity sensor in real time; and the controller compares a gravity value detected by the gravity sensor and a value stored by the memory module to get the gravity center change of the human body, and controls the wheel speeds and/or directions through the drive motor and the decelerating device based on the gravity center change.

Further, the gravity sensor includes one or one set of gravity sensors, and is arranged underneath the footrest of the electric scooter such that when the gravity increment value applied to the gravity sensor is positive and exceeds a set value, the controller drives the electric scooter to move forward or accelerate through the drive motor; and when the gravity increment value applied to the gravity sensor is negative and exceeds a set value, the controller controls the electric scooter to decelerate, stop or move backward through the drive motor and the decelerating device.

Further, the gravity sensor includes one or one set of gravity sensors, and is arranged at a left side or a right side underneath the footrest of the electric scooter such that when the gravity increment value applied to the gravity sensor exceeds a set value, the controller determines that the gravity center of the human body has changed.

Further, the gravity sensor control system for an electric scooter includes two or two sets of gravity sensors, and the controller gets the gravity center change of the human body by comparing gravity values detected by the two or two sets of gravity sensors.

Further, the two or two sets of gravity sensors are arranged underneath the footrest of the electric scooter and at a location for placing a foot, wherein one or one set of gravity sensors are arranged at a sole location of the foot, and the other one or set of gravity sensors are arranged at a heel location of the foot;

specifically, when the electric scooter has a design of forward and backward feet placement, the two or two sets of gravity sensors are arranged underneath the footrest of the electric scooter and at a location for placing a forward foot, wherein one or one set of gravity sensors are arranged at a sole location of the forward foot, and the other one or set of gravity sensors are arranged at a heel location of the forward foot; and when the electric scooter has a design of left and right feet placement, the two or two sets of gravity sensors are arranged underneath the footrest of the electric scooter and at a location for placing a left foot or a right foot of the human body, wherein one or one set of gravity sensors are arranged at a sole location of the left foot or the right foot, and the other one or set of gravity sensors are arranged at a heel location of the left foot or the right foot.

Further, the two or two sets of gravity sensors are arranged underneath the footrest of the electric scooter, wherein one or one set of gravity sensors are arranged at a location for placing one foot, and the other one or set of gravity sensors are arranged at a location for placing the other foot.

Further, the gravity sensor control system for an electric scooter includes a plurality of or a plurality of sets of gravity sensors; the gravity sensors are arranged at locations for placing the soles and heels of two feet; when the difference between the sum of gravities detected by the gravity sensors at soles locations of the two feet and the sum of gravities detected by the gravity sensors at heel locations of the two feet is larger than a set parameter value, the controller determines that the gravity center of the human body has changed by shifting forward or shifting backward, and regulates and controls the drive motor or the decelerating device based on the change.

Further, the electric scooter is a single-wheel electric scooter with an auxiliary wheel, a two-wheel electric scooter, a three-wheel electric scooter, a four-wheel electric scooter, or an electric scooter with more than four wheels.

### (III) Beneficial Effects

The above technical solutions of the present invention has the following beneficial effects: The gravity sensor control system of the present invention is more humanized, and capable of getting an intention of a driver to accelerate, decelerate or turn based on a slight change of a gravity center of a human body, with many manipulating devices omitted, thus achieving simpler and more convenient manipulation, and improved safety performance.

### BRIEF DESCRIPTION OF THE DRAWINGS

FIG. 1 is a schematic structural diagram of an embodiment of the present invention;

FIG. 2 is a schematic structural diagram of an embodiment of the present invention in which a single-wheel electric scooter is provided with one gravity sensor;

FIG. 3 is a schematic structural diagram of an embodiment of the present invention in which a two-wheel electric scooter is provided with one gravity sensor;

FIG. 4 is a schematic structural diagram of an embodiment of the present invention in which an electric scooter having two drive wheels with one auxiliary wheel is provided with one gravity sensor;

FIG. 5 is a schematic structural diagram of an embodiment of the present invention in which a single-wheel electric scooter with an auxiliary wheel is provided with two gravity sensors;

FIG. 6 is a schematic structural diagram of an embodiment of the present invention in which a two-wheel electric scooter is provided with two gravity sensors;

FIG. 7 is a schematic structural diagram of an embodiment of the present invention in which a three-wheel electric scooter is provided with two gravity sensors;

FIG. 8 is a schematic structural diagram of an embodiment of the present invention in which a four-wheel electric scooter is provided with two gravity sensors;

FIG. 9 is a schematic structural diagram of an embodiment of the present invention in which an electric scooter having two drive wheels with an auxiliary wheel is provided with two gravity sensors;

FIG. 10 is a schematic structural diagram of an embodiment of the present invention in which an electric scooter having two drive wheels with two follower wheels is provided with a plurality of gravity sensors;

### REFERENCE SIGNS

1: gravity sensor; 2: drive wheel; 3: electric scooter; 3b: single-wheel electric scooter with an auxiliary wheel; 3c: two-wheel electric scooter; 3d: three-wheel electric scooter; 3e: four-wheel electric scooter; 3f: electric scooter having two drive wheels with an auxiliary wheel.

### DETAILED DESCRIPTION

Implementations of the present invention are further described in detail below in conjunction with the accompanying drawings and embodiments. The following embodiments are used for illustrating the present invention instead of limiting the scope of the present invention.

In description of the present invention, unless otherwise indicated, the meaning of “a plurality of” is two or more; and orientation or location relations denoted by the terms “upper”, “lower”, “left”, “right”, “inner”, “outer”, “front end”, “rear end”, “head”, “tail” and the like are orientation or location relations based on illustration in the figures, are intended to facilitate describing the present invention and simplifying description, instead of indicating or implying that the denoted devices or elements necessarily have specific orientations and are constructed and operated in specific orientations, and thus they cannot be understood as limiting the present invention. In description of the present invention, it should be noted that unless otherwise explicitly specified and defined, the terms “connected” and “connection” should be construed broadly. For example, they may denote fixed connection, may also denote detachable connection, or integrated connection; may denote mechanical connection, and may also denote electric connection; may denote direction connection, and may also denote connection via an intermediate medium. For a person of ordinary skill in the art, specific meanings of the above-mentioned terms in the present invention may be construed according to specific conditions.

As shown in FIG. 1, a gravity sensor control system for an electric scooter of the embodiment includes a controller, and a gravity sensor, a drive motor and a decelerating device connected to the controller respectively, wherein the drive motor and the decelerating device are connected to wheels respectively; the gravity sensor is arranged underneath a footrest of the electric scooter and used for detecting the gravity supported by the footrest; and the controller gets a gravity center change of a human body based on a gravity variation value, namely increment value, detected by the gravity sensor, and controls wheel speeds, turning directions and/or backing through the drive motor and the decelerating device based on the gravity center change.

Specifically, when a gravity center of the human body shifts forward, the controller drives the electric scooter to move forward or accelerate through the drive motor; when the gravity of the human body shifts backward, the controller controls the electric scooter to decelerate, stop or move backward through the drive motor and the decelerating device; using a four-wheel electric scooter as an example, the scooter is backed in such a manner that the gravity center of the human body shifts backward, and after the controller controls the electric scooter to decelerate and stop through the drive motor and the decelerating device, the gravity center of the human body continues shifting backward, and when a set backing value is reached, the controller controls the scooter to move backward through the drive motor.

When the gravity of the human body shifts to the right, the controller controls a right wheel of the electric scooter to rotate more slowly or stop and a left wheel to maintain a speed through the drive motor or the decelerating device such that the electric scooter turns right; and when the gravity of the human body shifts to the left, the controller controls the left wheel of the electric scooter to rotate more slowly or stop and the right wheel to maintain a speed through the drive motor or the decelerating device such that the electric scooter turns left.

Further, to facilitate comparison to get a gravity variation on the gravity sensor, the controller comprises a memory module for recording and storing a gravity on the gravity sensor in real time; and the controller compares a gravity value detected by the gravity sensor and a value stored by the memory module to get the gravity center change of the human body, and controls the wheel speeds, turning directions and/or backing through the drive motor and the decelerating device based on the gravity center change.

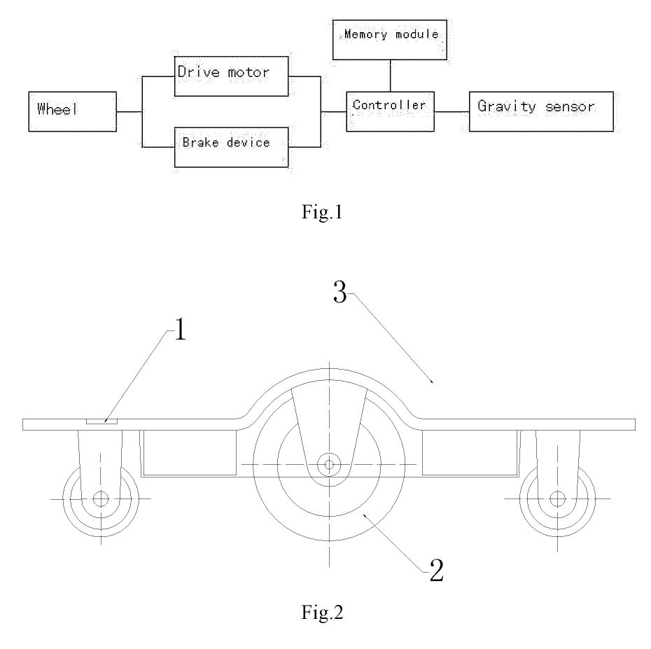

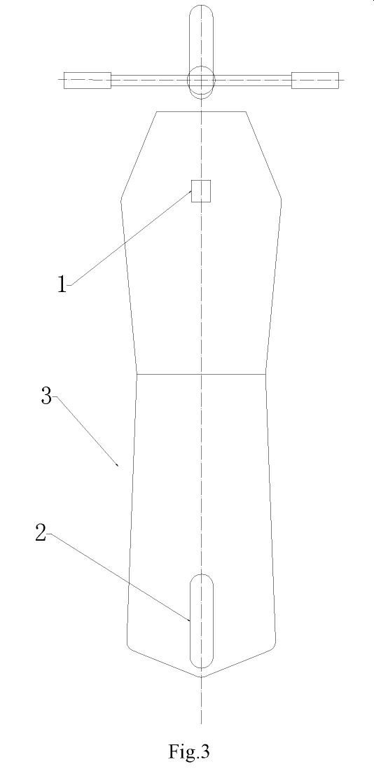

FIGS. 2 and 3 show electric scooters 3 which are a single-wheel electric scooter and a two-wheel electric scooter respectively; its control system is provided only with one gravity sensor 1 which is arranged underneath a footrest of the electric scooter and close to a scooter head, such that when the gravity variation value, namely increment value applied to the gravity sensor 1 is positive and exceeds a set value, the controller regulates and controls a drive motor to cause a drive wheel 2 to move forward or accelerate; and when the gravity variation value, namely increment value applied to the gravity sensor 1 is negative and exceeds a set value, the controller controls the electric scooter to decelerate, stop or move backward through the drive motor and a decelerating device.

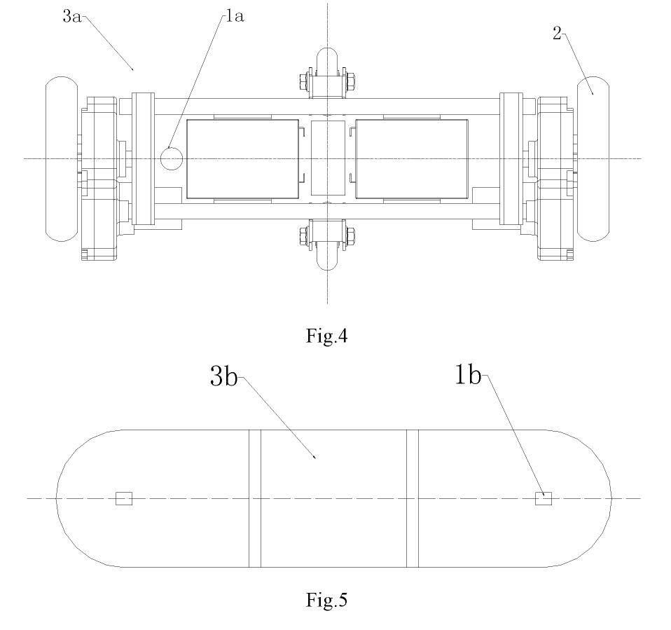

FIG. 4 shows an electric scooter 3a which is an electric scooter having two drive wheels with one auxiliary wheel; its control system is provided only with one gravity sensor 1a which is arranged underneath a left footrest of the electric scooter, such that when a gravity variation value applied to the gravity sensor 1a is positive and exceeds a set value, the controller determines that the gravity center of the human body has changed, and the controller regulates and controls rotation speeds of the left wheel and the right wheel respectively through a left drive motor and a right drive motor, to achieve steering and even 360-degree in-situ rotation of the electric scooter.

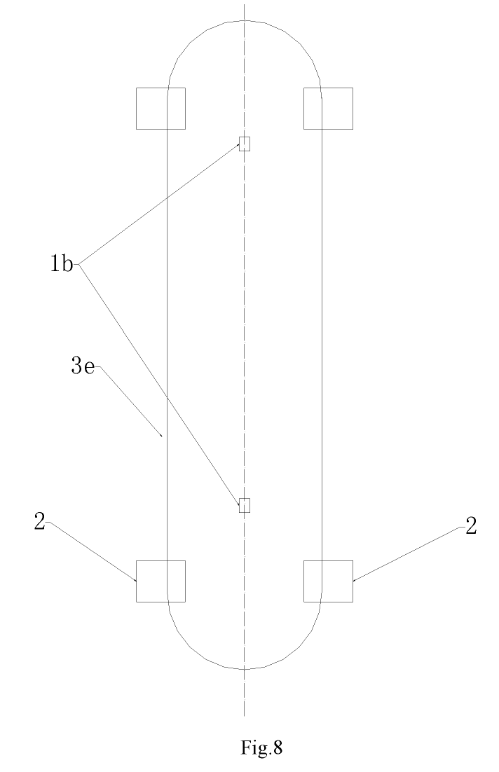

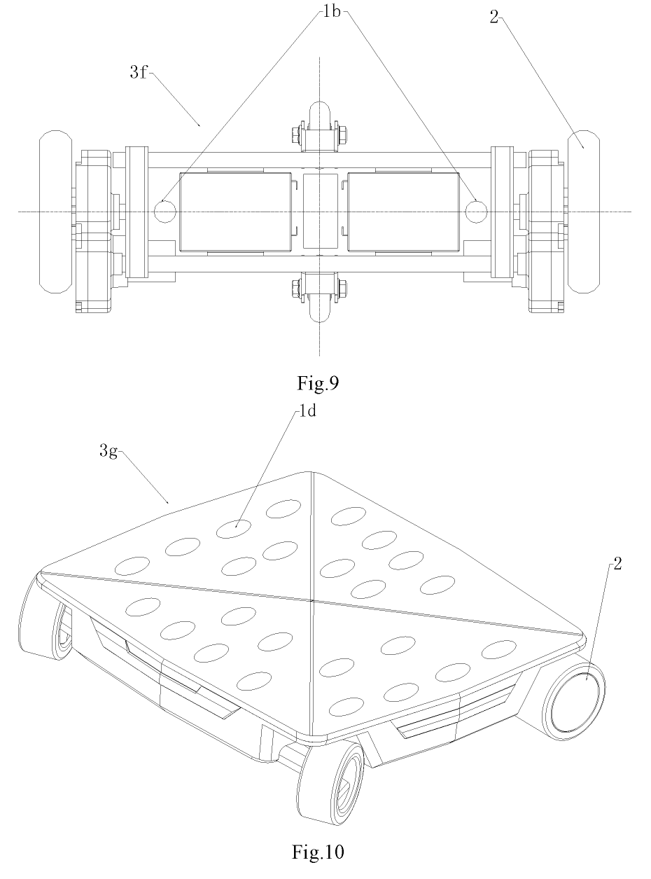

FIGS. 5-9 show gravity sensor control systems, each of which includes two or two sets of gravity sensors, and a controller gets a gravity center change of the human body by comparing gravity values detected by the two or two sets of gravity sensors, wherein reference sign 3b represents a single-wheel electric scooter with an auxiliary wheel; 3c represents a two-wheel electric scooter; 3d represents three-wheel electric scooter; 3e represents a four-wheel electric scooter; and 3f represents an electric scooter having two drive wheels with an auxiliary wheel.

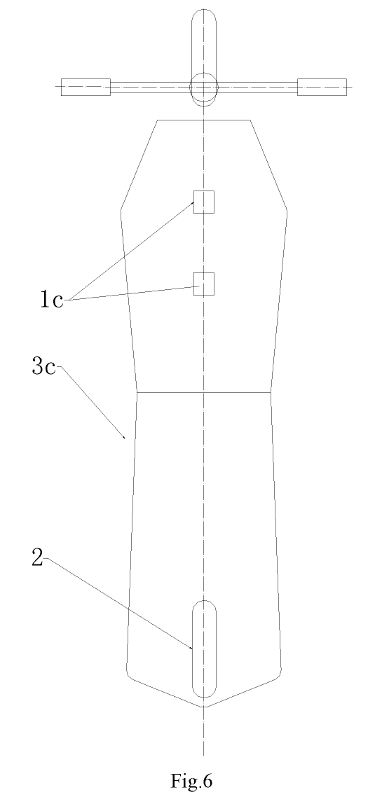

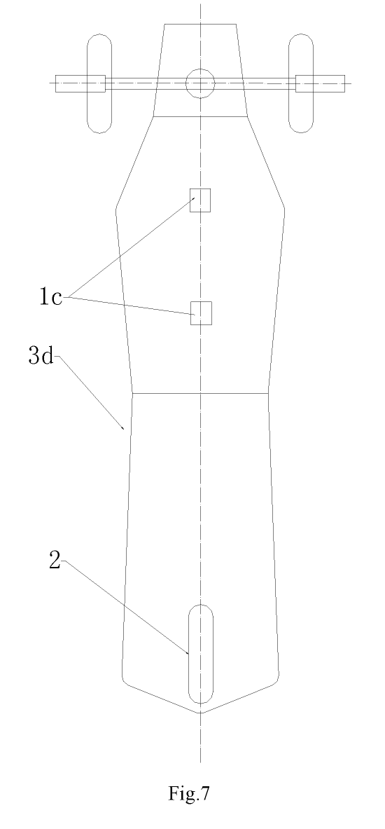

In FIGS. 6-7, the two or two sets of gravity sensors 1c are arranged underneath the footrest of the electric scooter and at a location for placing a forward foot, wherein one or one set of gravity sensors 1c are arranged at a sole location of the forward foot, and the other one or set of gravity sensors 1c are arranged at a heel location of the forward foot;

During traveling of the electric scooter, the forward foot of the driver does not need to move, and when the human body leans forward or leans backward, the gravity center of the human body shifts between the sole and the heel of the forward foot, and the controller gets an operation intention of the person via a slight variation acquired by the gravity sensor 1c, and accordingly decelerates or accelerates the scooter.

In FIGS. 5 and 8-9, the two or two sets of gravity sensors 1b are arranged underneath the footrest of the electric scooter, wherein one or one set of gravity sensors are arranged at a location for placing one foot, and the other one or set of gravity sensors are arranged at a location for placing the other foot. The controller gets an operation intention of the person by comparing gravity variations of the two feet.

In FIG. 10, an electric scooter 3g is an electric scooter having two drive wheels with two follower wheels, wherein a plurality of gravity sensors 1d are uniformly distributed on a footrest of the electric scooter and form a gravity sensor matrix, and the gravity sensors 1d are arranged at locations for placing the soles and heels of two feet respectively; when the difference between the sum of gravities detected by the gravity sensors 1d at soles locations of the two feet and the sum of gravities detected by the gravity sensors 1d at heel locations of the two feet is larger than a set parameter value, the controller determines that the gravity center of the human body has changed by shifting forward or shifting backward, and regulates and controls the drive motor or the decelerating device based on the change.

The embodiments of the present invention are provided for exemplification and description, instead of being exhaustive or limiting the present invention to the disclosed forms. Many modifications and variations are obvious to those of ordinary skill in the art. The embodiments are selected and described to better illustrate the principle and actual applications of the present invention and enable those of ordinary skill in the art to understand the present invention so as to design various embodiments with various modifications for specific uses.

1. A gravity sensor control system for an electric scooter, comprising a controller, and a gravity sensor, a drive motor and a decelerating device connected to the controller respectively, wherein the drive motor and the decelerating device are connected to wheels respectively; the gravity sensor is arranged underneath a footrest of the electric scooter and used for detecting the gravity supported by the footrest; and the controller gets a gravity center change of a human body based on a gravity variation value, namely increment value, detected by the gravity sensor, and controls wheel speeds and/or directions through the drive motor and the decelerating device based on the gravity center change.

2. The gravity sensor control system for an electric scooter of claim 1, wherein when a gravity center of the human body shifts forward, the controller drives the electric scooter to move forward or accelerate through the drive motor; when the gravity of the human body shifts backward, the controller controls the electric scooter to decelerate, stop or move backward through the drive motor and the decelerating device; when the gravity of the human body shifts to the right, the controller controls a right wheel of the electric scooter to rotate more slowly or stop and a left wheel to maintain a speed through the drive motor or the decelerating device such that the electric scooter turns right; and when the gravity of the human body shifts to the left, the controller controls the left wheel of the electric scooter to rotate more slowly or stop and the right wheel to maintain a speed through the drive motor or the decelerating device such that the electric scooter turns left.

3. The gravity sensor control system for an electric scooter of claim 2, wherein the scooter is backed in such a manner that the gravity center of the human body shifts backward, and after the controller controls the electric scooter to decelerate and stop through the drive motor and the decelerating device, the gravity center of the human body continues shifting backward, and when a set backing value is reached, the controller controls the scooter to move backward through the drive motor.

4. The gravity sensor control system for an electric scooter of claim 2, wherein the controller comprises a memory module for recording and storing the gravity on the gravity sensor in real time; and the controller compares a gravity value detected by the gravity sensor with a value stored by the memory module to get the gravity center change of the human body, and controls the wheel speeds and/or directions through the drive motor and the decelerating device based on the gravity center change.

5. The gravity sensor control system for an electric scooter of claim 4, wherein the gravity sensor includes one or one set of gravity sensors, and is arranged underneath the footrest of the electric scooter such that when the gravity increment value applied to the gravity sensor is positive and exceeds a set value, the controller drives the electric scooter to move forward or accelerate through the drive motor; and when the gravity increment value applied to the gravity sensor is negative and exceeds a set value, the controller controls the electric scooter to decelerate, stop or move backward through the drive motor and the decelerating device.

6. The gravity sensor control system for an electric scooter of claim 4, wherein the gravity sensor includes one or one set of gravity sensors, and is arranged at a left side or a right side underneath the footrest of the electric scooter such that when the gravity increment value applied to the gravity sensor exceeds a set value, the controller determines that the gravity center of the human body has changed.

7. The gravity sensor control system for an electric scooter of claim 2, wherein the gravity sensor control system for an electric scooter comprises two or two sets of gravity sensors, and the controller gets the gravity center change of the human body by comparing gravity values detected by the two or two sets of gravity sensors.

8. The gravity sensor control system for an electric scooter of claim 7, wherein the two or two sets of gravity sensors are arranged underneath the footrest of the electric scooter and at a location for placing a foot, wherein one or one set of gravity sensors are arranged at a sole location of the foot, and the other one or set of gravity sensors are arranged at a heel location of the foot; when the electric scooter has a design of forward and backward feet placement, the two or two sets of gravity sensors are arranged underneath the footrest of the electric scooter and at a location for placing a forward foot, wherein one or one set of gravity sensors are arranged at a sole location of the forward foot, and the other one or set of gravity sensors are arranged at a heel location of the forward foot; and when the electric scooter has a design of left and right feet placement, the two or two sets of gravity sensors are arranged underneath the footrest of the electric scooter and at a location for placing a left foot or a right foot of the human body, wherein one or one set of gravity sensors are arranged at a sole location of the left foot or the right foot, and the other one or set of gravity sensors are arranged at a heel location of the left foot or the right foot.

9. The gravity sensor control system for an electric scooter of claim 8, wherein the two or two sets of gravity sensors are arranged underneath the footrest of the electric scooter, wherein one or one set of gravity sensors are arranged at a location for placing one foot, and the other one or set of gravity sensors are arranged at a location for placing the other foot.

10. The gravity sensor control system for an electric scooter of claim 2, wherein the gravity sensor control system for an electric scooter comprises a plurality of or a plurality of sets of gravity sensors; the gravity sensors are arranged at locations for placing the soles and heels of two feet; when the difference between the sum of gravities detected by the gravity sensors at soles locations of the two feet and the sum of gravities detected by the gravity sensors at heel locations of the two feet is larger than a set parameter value, the controller determines that the gravity center of the human body has changed by shifting forward or shifting backward, and regulates and controls the drive motor or the decelerating device based on the change.
